(19) United States
(12) Patent Application Publication
(10) Pub. No.: US 2025/0183995 A1
(43) Pub. Date: Jun. 5, 2025

(54) DETERMINATION AND USAGE OF FRAME OF REFERENCE FOR NON-TERRESTRIAL NETWORK ORBITAL PARAMETERS IN MOBILE COMMUNICATIONS

(71) Applicant: MediaTek Singapore Pte. Ltd., Singapore (SG)

(72) Inventors: Abdelkader MEDLES, Cambridge (GB); Gilles CHARBIT, Cambridge (GB)

(21) Appl. No.: 18/844,928

(22) PCT Filed: Mar. 23, 2023
(86) PCT No.: PCT/CN2023/083456

§ 371 Date: Sep. 6, 2024

Related U.S. Application Data
(60) Provisional application No. 63/324,197, filed on Mar. 28, 2022.

(51) Int. Cl. H04B 7/185

(52) U.S. Cl. CPC H04B 7/18513

(57) ABSTRACT

Various solutions for determination and usage of frame of reference for non-terrestrial network (NTN) orbital parameters in mobile communications are described. An apparatus (e.g., a UE) determines one or more orbital parameters defined in an inertial reference frame. The apparatus then performs NTN communications according to the one or more orbital parameters.

### CROSS REFERENCE TO RELATED PATENT APPLICATION(S)

The present disclosure is part of a non-provisional application claiming the priority benefit of U.S. Patent Application No. 63/324,197, filed 28 Mar. 2022, the content of which being incorporated by reference in its entirety.

### TECHNICAL FIELD

The present disclosure is generally related to mobile communications and, more particularly, to determination and usage of frame of reference for non-terrestrial network (NTN) orbital parameters in mobile communications.

### BACKGROUND

Unless otherwise indicated herein, approaches described in this section are not prior art to the claims listed below and are not admitted as prior art by inclusion in this section.

In NTN communication in accordance with one or more 3rd Generation Partnership Project (3GPP) specifications, an NTN synchronization system information block (SIB) typically contains ephemeris information in an orbital parameters form (e.g., ephemeris set 2). Some of the orbital parameters, such as position and velocity, are defined in the context of an Earth-Centered, Earth-Fixed (ECEF) frame. The ECEF, however, is not an inertial reference frame (as it rotates with the Earth). As such, the reference frame for the orbital parameters tends to have two constraints. One constraint is that there needs to be an inertial reference frame so that the orbital parameters are valid (as the orbital parameters are only valid in the inertial reference frame which experiences no acceleration). Another constraint is that the orbital parameters are valid at an epoch time with respect to the ECEF or an Earth-fixed reference frame so that a user equipment (UE) does not need to acquire an absolute time. Therefore, there is a need for a solution of determination and usage of frame of reference for NTN orbital parameters in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues. More specifically, various schemes proposed in the present disclosure are believed to address issues pertaining to determination and usage of frame of reference for NTN orbital parameters in mobile communications. For instance, under the proposed schemes, certain orbital parameters (e.g., a, e, o, Q, I, and M) used in NTN communications may be defined in an inertial reference frame such as an Earth Centered Inertial (ECI) frame. The ECI frame and ECEF frame may coincide at an epoch time (e.g., x, y and z axes in ECEF may be aligned with x, y and z axes in ECI). Under the proposed schemes, the information element (IE) EphemerisInfo may provide satellite ephemeris expressed either in the format of position and velocity state vectors in ECEF or in the format of orbital parameters in ECI. Moreover, the IE EphemerisOrbitalParameters may provide satellite ephemeris in the format of orbital parameters in the ECI frame.

In one aspect, a method may involve an apparatus (e.g., a UE) determining one or more orbital parameters defined in an inertial reference frame. The method may also involve the processor performing NTN communications according to the one or more orbital parameters.

In another aspect, an apparatus may include a transceiver and a processor coupled to the transceiver. The transceiver may be configured to communicate wirelessly. The processor may determine one or more orbital parameters defined in an inertial reference frame. The processor may then perform NTN communications according to the one or more orbital parameters.

It is noteworthy that, although description provided herein may be in the context of certain radio access technologies, networks and network topologies such as NTN communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, 5th Generation (5G), New Radio (NR), Internet-of-Things (IoT), Narrow Band Internet of Things (NB-IoT), Industrial Internet of Things (IIOT), vehicle-to-vehicle (V2V) and vehicle-to-everything (V2X) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a block diagram of an example communication system in accordance with an implementation of the present disclosure.

FIG. 3 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to determination and usage of frame of reference for NTN orbital parameters in mobile communications. According to the present disclosure, a number of possible solutions may be implemented separately or jointly. That is, although these possible solutions may be described below separately, two or more of these possible solutions may be implemented in one combination or another.

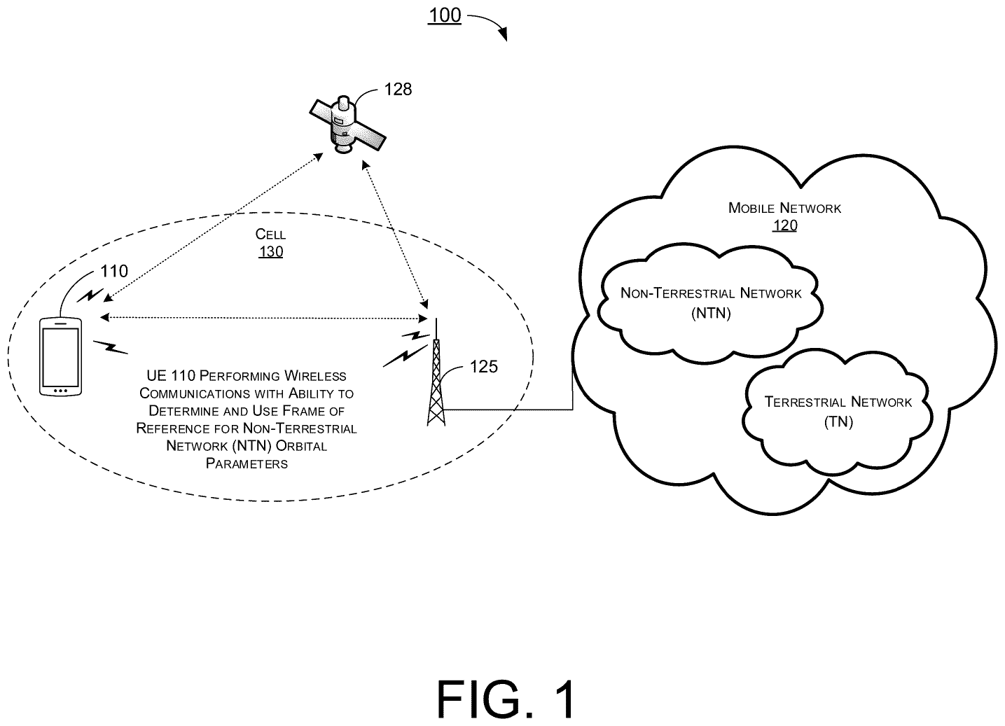

FIG. 1 illustrates an example network environment 100 in which various proposed schemes in accordance with the present disclosure may be implemented. Network environment 100 may involve a UE 110 and a mobile network 120 (e.g., an LTE network, a 5G network, an NR network, an IoT network, an NB-IoT network, an IIOT network, a terrestrial network and/or an NTN network). UE 110 may communicate with mobile network 120 via a non-terrestrial (NT) network node 128 (e.g., a satellite) and/or a terrestrial network node 125 (e.g., a gateway, base station, eNB, gNB or transmission/reception point (TRP)). Under various proposed schemes in accordance with the present disclosure, each of UE 110, NT network node 128 and terrestrial network node 125 may be configured to perform operations pertaining to determination and usage of frame of reference for NTN orbital parameters in mobile communications, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

Under various proposed schemes in accordance with the present disclosure, an NTN synchronization SIB may be used by UE 110 in NTN communications for synchronization with a serving satellite (e.g., NT network node 128) or a base station (e.g., terrestrial network node 125). The NTN synchronization SIB may contain ephemeris information (set 2) such as, for example and without limitation, semi-major axis α [m], eccentricity e, argument of periapsis ω [rad], longitude of ascending node Ω [rad], inclination I [rad], and mean anomaly M [rad] at epoch time. Under the proposed schemes, the epoch time or reference time for the validity of the SIB may be the downlink (DL) time and may be signaled either implicitly (e.g., system information (SI) window time frame boundary) or explicitly (e.g., system frame number (SFN)) on the SIB or via dedicated radio resource control (RRC) signaling.

Under a first proposed scheme in accordance with the present disclosure, orbital parameters may be defined in an inertial reference frame. For instance, the orbital parameters may be defined in the ECI frame. Under the proposed scheme, the ECI frame and ECEF frame may coincide at the epoch time (e.g., x, y and z axes in ECEF being aligned with x, y and z axes in ECI). Moreover, the orbital parameters and epoch time may be broadcast in a serving cell and/or in one or more neighboring cells. Furthermore, the orbital parameters and the epoch time may be provided by dedicated RRC signaling for the serving cell and/or the one or more neighboring cells.

Under a second proposed scheme in accordance with the present disclosure, an initial time at which the ECI frame and ECEF frame coincide may be different from the epoch time. Additionally, the initial time may be signaled independently and may be defined in SNF and/or hyper frame number (HFN). Moreover, the epoch time may allow UE 110 to generate a position of UE 110 by taking into account the movement of the Earth between the initial time and the epoch time.

Under a third proposed scheme in accordance with the present disclosure, UE 110 may receive orbital parameters with ECI frame and ECEF frame coinciding at an epoch time. That is, the x, y and z axes in the ECEF frame may be aligned with the x, z, z axes in the ECI frame. Under the proposed scheme, the orbital parameters and the epoch time may be broadcast on an SIB in a serving cell of UE 110. Alternatively, or additionally, the orbital parameters and the epoch time may be broadcast on an SIB in a neighboring cell of UE 110. Alternatively, or additionally, the orbital parameters and the epoch time may be provided via a dedicated RRC signaling for the neighboring cell. Under the proposed scheme, an initial time at which the ECI frame and the ECEF frame coincide may be different from the epoch time, and the initial time may be signaled independently. Moreover, the initial time may be defined in SFN and/or HFN.

### Illustrative Implementations

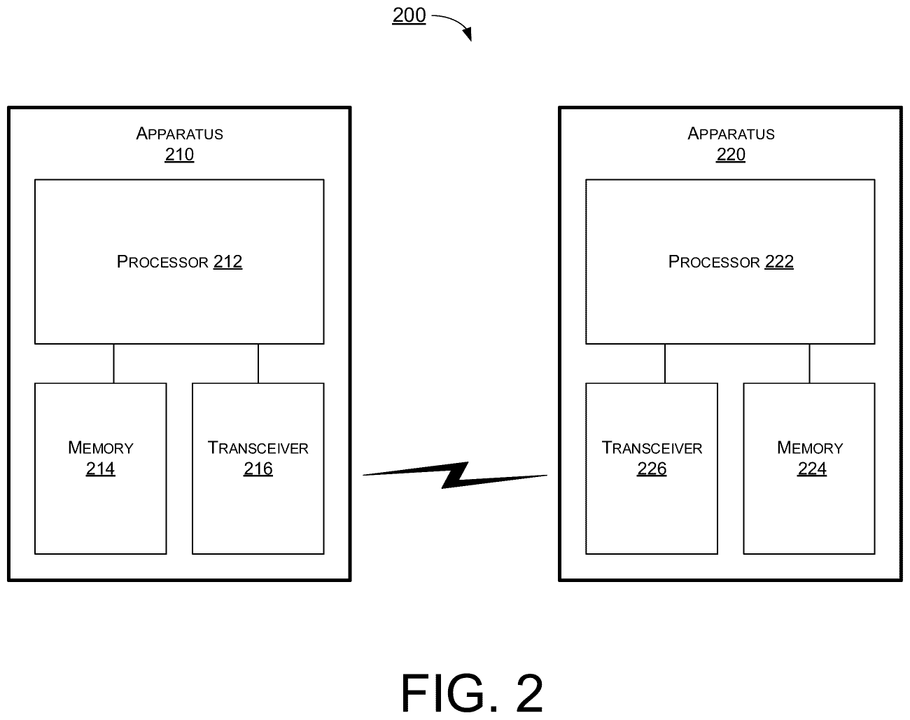

FIG. 2 illustrates an example communication system 200 having an example communication apparatus 210 and an example network apparatus 220 in accordance with an implementation of the present disclosure. Each of communication apparatus 210 and network apparatus 220 may perform various functions to implement schemes, techniques, processes and methods described herein pertaining to determination and usage of frame of reference for NTN orbital parameters in mobile communications, including scenarios/schemes described above as well as process(es) described below.

Communication apparatus 210 may be a part of an electronic apparatus, which may be a UE such as a portable or mobile apparatus, a wearable apparatus, a wireless communication apparatus or a computing apparatus. For instance, communication apparatus 210 may be implemented in a smartphone, a smartwatch, a personal digital assistant, a digital camera, or a computing equipment such as a tablet computer, a laptop computer or a notebook computer. Communication apparatus 210 may also be a part of a machine type apparatus, which may be an IoT, NB-IoT, IIoT or NTN apparatus such as an immobile or a stationary apparatus, a home apparatus, a wire communication apparatus or a computing apparatus. For instance, communication apparatus 210 may be implemented in a smart thermostat, a smart fridge, a smart door lock, a wireless speaker or a home control center. Alternatively, communication apparatus 210 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 210 may include at least some of those components shown in FIG. 2 such as a processor 212, for example. Communication apparatus 210 may further include one or more other components not pertinent to the proposed scheme of the present disclosure (e.g., internal power supply, display device and/or user interface device), and, thus, such component(s) of communication apparatus 210 are neither shown in FIG. 2 nor described below in the interest of simplicity and brevity.

Network apparatus 220 may be a part of an electronic apparatus/station, which may be a network node such as a base station, a small cell, a router, a gateway or a satellite. For instance, network apparatus 220 may be implemented in an eNodeB in an LTE, in a gNB in a 5G, NR, IoT, NB-IoT, IIOT, or in a satellite in an NTN network. Alternatively, network apparatus 220 may be implemented in the form of one or more IC chips such as, for example and without limitation, one or more single-core processors, one or more multi-core processors, or one or more RISC or CISC processors. Network apparatus 220 may include at least some of those components shown in FIG. 2 such as a processor 222, for example. Network apparatus 220 may further include one or more other components not pertinent to the proposed scheme of the present disclosure (e.g., internal power supply, display device and/or user interface device), and, thus, such component(s) of network apparatus 220 are neither shown in FIG. 2 nor described below in the interest of simplicity and brevity.

In one aspect, each of processor 212 and processor 222 may be implemented in the form of one or more single-core processors, one or more multi-core processors, one or more RISC processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including determination and usage of frame of reference for NTN orbital parameters in mobile communications in accordance with various implementations of the present disclosure.

In some implementations, communication apparatus 210 may also include a transceiver 216 coupled to processor 212 and capable of wirelessly transmitting and receiving data. In some implementations, communication apparatus 210 may further include a memory 214 coupled to processor 212 and capable of being accessed by processor 212 and storing data therein. In some implementations, network apparatus 220 may also include a transceiver 226 coupled to processor 222 and capable of wirelessly transmitting and receiving data. In some implementations, network apparatus 220 may further include a memory 224 coupled to processor 222 and capable of being accessed by processor 222 and storing data therein. Accordingly, communication apparatus 210 and network apparatus 220 may wirelessly communicate with each other via transceiver 216 and transceiver 226, respectively.

Each of communication apparatus 210 and network apparatus 220 may be a communication entity capable of communicating with each other using various proposed schemes in accordance with the present disclosure. To aid better understanding, the following description of the operations, functionalities and capabilities of each of communication apparatus 210 and network apparatus 220 is provided in the context of a mobile communication environment in which communication apparatus 210 is implemented in or as a communication apparatus or a UE (e.g., UE 110) and network apparatus 220 is implemented in or as a network node or base station (e.g., NT network node 128 or terrestrial network node 125) of a communication network (e.g., network 120). It is also noteworthy that, although the example implementations described below are provided in the context of NTN communications, the same may be implemented in other types of networks.

Under a proposed scheme pertaining to determination and usage of frame of reference for NTN orbital parameters in mobile communications in accordance with the present disclosure, with communication apparatus 210 implemented in or as UE 110 and network apparatus 220 implemented in or as NT network node 128 or terrestrial network node 125 in network environment 100, processor 212 of communication apparatus 210 may determine one or more orbital parameters defined in an inertial reference frame. Moreover, processor 212 may perform, via transceiver 216, NTN communications (e.g., with apparatus 220) according to the one or more orbital parameters.

In some implementations, the inertial reference frame may be an ECI frame.

In some implementations, the inertial reference frame and an ECEF frame may coincide at an epoch time (e.g., a DL time). For instance, x, y and z axes in the ECEF frame and x, y and z axes in the inertial reference frame may be aligned.

In some implementations, in determining the one or more orbital parameters, processor 212 may receive, via transceiver 216, the one or more orbital parameters and the epoch time in a broadcast by a serving cell and/or a neighboring cell. In such cases, the epoch time may correspond to a System Information Window time frame boundary where the orbital parameters were broadcast by the serving cell. Alternatively, or additionally, in determining the one or more orbital parameters, processor 212 may receive, via transceiver 216, the one or more orbital parameters and the epoch time in a dedicated RRC signaling from the serving cell and/or the neighboring cell. In such cases, the epoch time may correspond to a System Information Window time frame boundary where the orbital parameters were broadcast by the neighboring cell.

In some implementations, the inertial reference frame and the ECEF frame may coincide at an initial time different from an epoch time. In some implementations, the initial time may be defined in an SFN and/or an HFN.

### Illustrative Processes

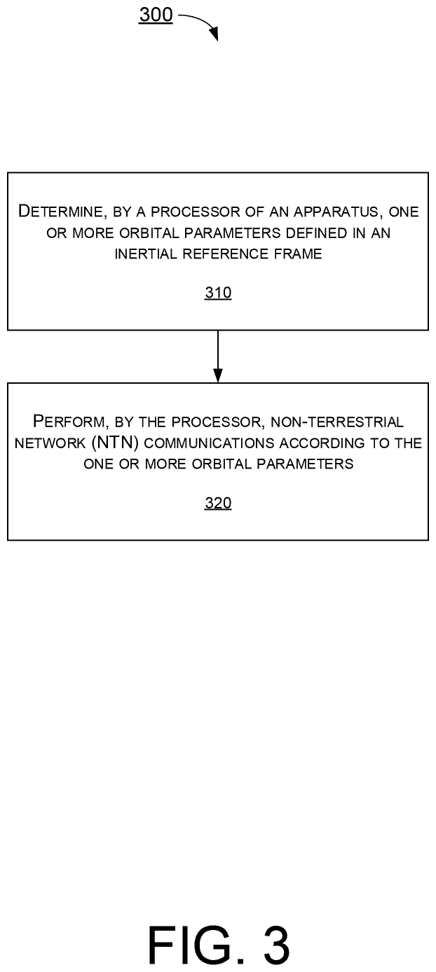

FIG. 3 illustrates an example process 300 in accordance with an implementation of the present disclosure. Process 300 may be an example implementation of schemes described above, whether partially or completely, with respect to determination and usage of frame of reference for NTN orbital parameters in mobile communications in accordance with the present disclosure. Process 300 may represent an aspect of implementation of features of communication apparatus 210. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks of process 300 may executed in the order shown in FIG. 3 or, alternatively, in a different order. Process 300 may be implemented by communication apparatus 210 or any suitable UE or machine type devices. Solely for illustrative purposes and without limitation, process 300 is described below in the context of communication apparatus 210 and network apparatus 220. Process 300 may begin at block 310.

At 310, process 300 may involve processor 212 of communication apparatus 210 determining one or more orbital parameters defined in an inertial reference frame. Process 300 may proceed from 310 to 320.

At 320, process 300 may involve processor 212 performing, via transceiver 216, NTN communications according to the one or more orbital parameters.

In some implementations, the inertial reference frame may be an ECI frame.

In some implementations, the inertial reference frame and an ECEF frame may coincide at an epoch time (e.g., a DL time). For instance, x, y and z axes in the ECEF frame and x, y and z axes in the inertial reference frame may be aligned.

In some implementations, in determining the one or more orbital parameters, process 300 may involve processor 212 receiving, via transceiver 216, the one or more orbital parameters and the epoch time in a broadcast by a serving cell and/or a neighboring cell. In such cases, the epoch time may correspond to a System Information Window time frame boundary where the orbital parameters were broadcast by the serving cell. Alternatively, or additionally, in determining the one or more orbital parameters, process 300 may involve processor 212 receiving, via transceiver 216, the one or more orbital parameters and the epoch time in a dedicated RRC signaling from the serving cell and/or the neighboring cell. In such cases, the epoch time may correspond to a System Information Window time frame boundary where the orbital parameters were broadcast by the neighboring cell.

In some implementations, the inertial reference frame and the ECEF frame may coincide at an initial time different from an epoch time. In some implementations, the initial time may be defined in an SFN and/or an HFN.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, one or more orbital parameters defined in an inertial reference frame; and
performing, by the processor, non-terrestrial network (NTN) communications according to the one or more orbital parameters.

2. The method of claim 1, wherein the inertial reference frame comprises an Earth Centered Inertial (ECI) frame.

3. The method of claim 1, wherein the inertial reference frame and an Earth-Centered, Earth-Fixed (ECEF) frame coincide at an epoch time.

4. The method of claim 3, wherein x, y and z axes in the ECEF frame and x, y and z axes in the inertial reference frame are aligned.

5. The method of claim 3, wherein the determining of the one or more orbital parameters comprises receiving the one or more orbital parameters and the epoch time in a broadcast by a serving cell.

6. The method of claim 5, wherein the epoch time corresponds to a System Information Window time frame boundary where the orbital parameters were broadcast by the serving cell.

7. The method of claim 3, wherein the determining of the one or more orbital parameters comprises receiving the one or more orbital parameters and the epoch time in a broadcast by a neighboring cell.

8. The method of claim 7, wherein the epoch time corresponds to a System Information Window time frame boundary where the orbital parameters were broadcast by the neighboring cell.

9. The method of claim 3, wherein the determining of the one or more orbital parameters comprises receiving the one or more orbital parameters and the epoch time in a radio resource control (RRC) signaling from a serving cell.

10. The method of claim 3, wherein the determining of the one or more orbital parameters comprises receiving the one or more orbital parameters and the epoch time in a radio resource control (RRC) signaling from a neighboring cell.

11. The method of claim 1, wherein the inertial reference frame and an Earth-Centered, Earth-Fixed (ECEF) frame coincide at an initial time different from an epoch time, and wherein the initial time is defined in either or both of a system frame number (SFN) and a hyper frame number (HFN).

12. An apparatus implementable in a user equipment (UE), comprising:
a transceiver configured to communicate wirelessly; and
a processor coupled to the transceiver and configured to perform operations comprising:
determining one or more orbital parameters defined in an inertial reference frame; and
performing, via the transceiver, non-terrestrial network (NTN) communications according to the one or more orbital parameters.

13. The apparatus of claim 12, wherein the inertial reference frame comprises an Earth Centered Inertial (ECI) frame.

14. The apparatus of claim 12, wherein the inertial reference frame and an Earth-Centered, Earth-Fixed (ECEF) frame coincide at an epoch time.

15. The apparatus of claim 14, wherein x, y and z axes in the ECEF frame and x, y and z axes in the inertial reference frame are aligned.

16. The apparatus of claim 14, wherein the determining of the one or more orbital parameters comprises receiving, via the transceiver, the one or more orbital parameters and the epoch time in a broadcast by a serving cell.

17. The apparatus of claim 14, wherein the determining of the one or more orbital parameters comprises receiving, via the transceiver, the one or more orbital parameters and the epoch time in a broadcast by a neighboring cell.

18. The apparatus of claim 14, wherein the determining of the one or more orbital parameters comprises receiving, via the transceiver, the one or more orbital parameters and the epoch time in a radio resource control (RRC) signaling from a serving cell.

19. The apparatus of claim 14, wherein the determining of the one or more orbital parameters comprises receiving, via the transceiver, the one or more orbital parameters and the epoch time in a radio resource control (RRC) signaling from a neighboring cell.

20. The apparatus of claim 12, wherein the inertial reference frame and an Earth-Centered, Earth-Fixed (ECEF) frame coincide at an initial time different from an epoch time, and wherein the initial time is defined in either or both of a system frame number (SFN) and a hyper frame number (HFN).
